(19) United States
(12) Patent Application Publication
(10) Pub. No.: US 2005/0158075 A1
(43) Pub. Date: Jul. 21, 2005

(54) Heating apparatus, image fixing apparatus, and image forming apparatus

(76) Inventors: Katsuhiro Echigo, Saitama (JP); Shigeo Kurotaka, Kanagawa (JP); Hisashi Kikuchi, Kanagawa (JP); Yukimichi Someya, Saitama (JP); Hiroyuki Kunii, Kanagawa (JP); Atsushi Nakafuji, Tokyo (JP); Takashi Fujita, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/019,348

(22) Filed: Dec. 23, 2004

(30) Foreign Application Priority Data
Dec. 24, 2003 (JP) 2003-427159

(51) Int. Cl. G03G 15/20

(52) U.S. Cl. 399/122

(57) ABSTRACT

In an image fixing apparatus of an image forming apparatus, all the non-electrical components are assembled to form one unit and electrical components are arranged in a main body of the image forming apparatus.

### CROSS-REFERENCE TO RELATED APPLICATIONS

The present document incorporates by reference the entire contents of Japanese priority document, 2003-427159 filed in Japan on Dec. 24, 2003.

### BACKGROUND OF THE INVENTION

1) Field of the Invention

The present invention relates to a heating apparatus equipped with an inductive heating apparatus that heats a heat-generating material in an image fixing apparatus of an image forming apparatus.

2) Description of the Related Art

In image forming apparatuses, such as electrophotographic copiers, printers, facsimiles, and the like, images are formed by a transfer of toner images to a recordable media such as a plain paper, an overhead projection (OHP) film, and the like. Many image forming apparatuses employ an electrophotographic system in accordance with the needs for high-speed, better image quality, lower cost, and the like. The electrophotographic system forms toner images on the recordable media and fixes the formed images on the recordable media by an application of heat and pressure. From the viewpoint of safety, the image fixing most frequently involves application of heat using a heating roller. The heating roller has a heat-generating material such as a halogen heater (lamp) and a metallic core. The heating roller presses against an opposing compression roller. There is a nip section between the heating roller and the compression roller. The recordable media, which has a toner image copied onto it, is heated as it passes through the nip section, and is compressed by a pressurizing roller to fix a toner onto the recordable media.

However, from the viewpoint of energy-saving and shorter waiting time, an image fixing apparatus that has a heat-generating material that instantaneously heats up to a specified temperature and greatly reduces the waiting time of a user is demanded. But the heating roller cannot easily meet the demands of energy-saving because there is wastage of energy in the conventional heating roller, which is made mainly of iron or aluminum.

In recent years, image fixing apparatuses that use an inductive heating method have been proposed. Image fixing apparatuses that use the inductive heating method heat the recordable media by an electromagnetic induction of the heat-generating materials of a heating roller or a heating belt. The heating roller and the heating belt have an electromagnetic conductive layer on or below an outer layer. This technology does not have problems of flicker and the like that occur in the above-mentioned conventional technology that uses the metallic heating roller. The inductive heating method saves energy by instantaneously heating only the heating roller and the heating belt, and is extremely effective for providing image fixing apparatuses that have a short waiting time.

A conventional technology has been disclosed in Japanese Patent Application Laid-Open No. 2002-29693.

In the conventional image fixing apparatuses that use the inductive heating method, a temperature-detecting unit is placed near a nip section. The temperature-detecting unit includes a high-response temperature sensing element such as a thermistor. The temperature-detecting unit detects a surface temperature of the heating roller or the heating belt so that the temperature of the heating roller or the heating belt can be controlled to a specified temperature. However, in such image fixing apparatuses abrasion is caused by a contact between the heating roller and the recording media during an image fixing. This abrasion produces scratches, and the like on the surface of the heating roller or the heating belt. In this event, the entire image fixing apparatus is usually exchanged with a new one. In other words, not only the heating roller or the heating belt, but also still-usable components such as an induction coil unit, the thermostat, the thermistor, a revolving detecting unit, and accompanying harness components, connectors, and the like, are replaced. This results in a costly image fixing apparatus.

### SUMMARY OF THE INVENTION

It is an object of the present invention to at least solve the problems in the conventional technology.

A heating apparatus according to an aspect of the present invention includes a mechanical assembly that is detachably attached to a host apparatus, and includes a revolving body that generates heat due to electromagnetic induction; and an electrical assembly that is fixed to the host apparatus, and generates a magnetic field for the electromagnetic induction.

An image fixing apparatus according to another aspect of the present invention fixes an image on a recording medium by applying pressure and heat. The image fixing apparatus includes a mechanical assembly that is detachably attached to an image forming apparatus, and includes a revolving body that generates the pressure and generates the heat due to electromagnetic induction; and an electrical assembly that is fixed to the image forming apparatus, and generates a magnetic field for the electromagnetic induction.

An image forming apparatus according to still another aspect of the present invention includes an image developing apparatus that forms a toner image on an image holding body; an image transferring apparatus that transfers the toner image to a recording medium; and an image fixing apparatus that fixes the toner image to the recording medium by applying pressure and heat. The image fixing apparatus includes a mechanical assembly that is detachably attached to the image forming apparatus, and includes a revolving body that generates the pressure and generates the heat due to electromagnetic induction; and an electrical assembly that is fixed to the image forming apparatus, and generates a magnetic field for the electromagnetic induction.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic side-view of an electrophotographic image forming apparatus and an image fixing apparatus according to an embodiment of the present invention;

FIGS. 2A and 2B are schematic side-views of a heating apparatus and an image fixing apparatus according to a first embodiment of the present invention; and

FIGS. 3A and 3B are schematic side-views of a heating apparatus and an image fixing apparatus according to a second embodiment of the present invention.

### DETAILED DESCRIPTION

Exemplary embodiments of a heating apparatus, an image fixing apparatus, and an image forming apparatus according to the present invention are explained below in reference to the accompanying drawings.

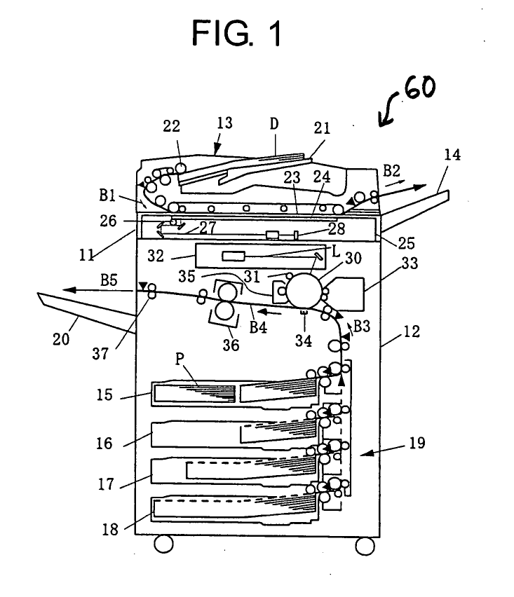

FIG. 1 is a schematic side-view of an electrophotographic image forming apparatus 60 that employs a heating apparatus and an image fixing apparatus, both according to the present invention. The image forming apparatus 60 includes an image reading unit 11, an image forming unit 12, an automatic document feeder (hereinafter, “ADF”) 13, a document tray 14 that stacks documents discharged from the ADF 13, a paper feeding unit 19 equipped with paper feeding cassettes 15 to 18, and a copy tray 20 that stacks copies.

The ADF 13 is located above a document feeder 21. A document D is set onto the ADF 13. The image forming apparatus 60 functions based on how a user operates an operations unit (not shown). For example, if a print key is pressed, the uppermost document D is sent in the direction of arrow B1 by a revolving of a pick-up roller 22. A document conveyance belt 23 conveys the document D to an exposure glass 24 that is affixed to the image reading unit 11, then the document conveyance belt 23 stops. An image reading apparatus 25, that is located between the image forming unit 12 and the exposure glass 24, reads image information of a surface of the document D. Specifically, the image reading apparatus 25 includes a light source 26 that illuminates the document D on the exposure glass 24, an optical system 27 that optically scans the surface of the document D, and a photoelectric converting element 28 that includes a charge-coupled device (CCD) and the like that forms an optical image of surface of the document D. Once the optical image is read, the document D is conveyed in the direction of arrow B2 to the document tray 14 by the revolving of the document conveyance belt 23. In this manner, documents are placed sheet-by-sheet on the exposure glass 14, and the image reading unit 11 reads an optical image of a surface of each of the documents.

The image forming unit 12 includes a photosensitive drum 30. The photosensitive drum 30 holds the optical image read by the image reading apparatus 25. Specifically, the photosensitive drum 30 revolves in a clockwise direction and an electrostatic charging apparatus 31 charges a predetermined electrical potential on a surface of the photosensitive drum 30. An image writing unit 32 irradiates the photosensitive drum 30 with a laser light L that is modulated according to the optical image read by the image reading apparatus 25. The surface of the electrostatically-charged photosensitive drum 30 is exposed to the laser light L, which results in an electrostatic latent image on the surface of the photosensitive drum 30. When this electrostatic latent image on the photosensitive drum 30 moves past an image developing apparatus 33, toner contained in the image developing apparatus 33 accrues to the surface of the photosensitive drum 30, which results in a toner image. An image transferring apparatus 34 charges a recordable media P that passes between the image transferring apparatus 34 and the photosensitive drum 30, and the toner image is transferred onto the recordable media P. Once the toner image is transferred onto the recordable media P, a cleaning apparatus 35 cleans the excess toner that remains on the surface of the photosensitive drum 30.

The paper feeding cassettes 15 to 18 are positioned below the image forming unit 12. Each paper feeding cassette accommodates recordable media P, such as plain paper and the like, of different sizes. The recordable media P is sent in the direction of arrow B3 from any one of the paper feeding cassettes 15 to 18. The toner image formed on the surface of the photosensitive drum 30 is copied onto the surface of the recordable media P. Next, the recordable media P passes, in the direction of arrow B4, through an image fixing apparatus 36. The image fixing apparatus 36 fixes the toner image onto the surface of the recordable media P by the application of heat and pressure. Copy discharging rollers 37 convey the recordable media P with the toner image fixed thereon in the direction of arrow B5 so that the recordable media P is stacked into the copy tray 20.

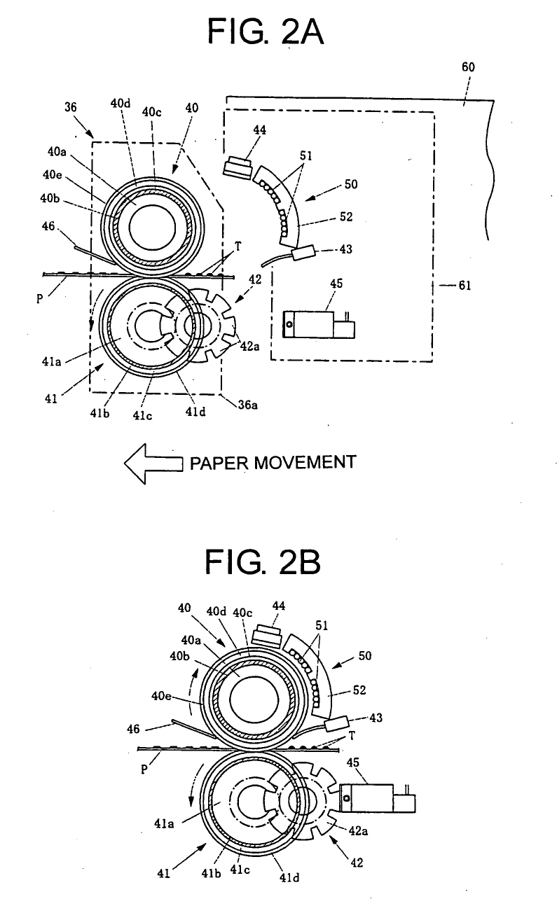

FIGS. 2A and 2B are schematic side-views of a heating apparatus and an image fixing apparatus 36 according to a first embodiment of the present invention. Specifically, FIG. 2A is the schematic side-view of the heating apparatus detached from the image fixing apparatus 36 and FIG. 2B is the schematic side-view of the heating apparatus attached to the image fixing apparatus 36.

The image fixing apparatus 36 includes a heating roller 40 and a pressurizing roller 41. The heating roller 40 is heated by an induction-heating unit 50. An axis around which the heating roller 40 rotates is parallel with and an axis around which the pressurizing roller 41 rotates.

At the center of the heating roller 40 is a metallic tube 40a. An insulating layer 40b, a heating layer 40c, an elastic layer 40d, and an exfoliating layer 40e are successively laminated on the metallic tube 40a. It is preferable that the metallic tube 40a is made of aluminum or iron of an appropriate thickness to prevent a bending of the metallic tube 40a. However, tubes made of resin, glass, ceramic, and the like may be used instead of the metallic tube 40a.

The insulating layer 40b controls thermal conduction from the heating layer 40c to the metallic roller core 40a. The insulating layer 40b is a foamed silicon rubber of an appropriate hardness. It is also acceptable to make the insulating layer 40b of a material other than a foamed silicon rubber; for example, a similar heat-resistant elastomer such as a fluorocarbon rubber can be employed. Although it is acceptable to use a non-foamed solid silicon rubber for the insulating layer 40b, a foamed silicon rubber is preferable from the viewpoints of a low thermal conductivity ratio and a smaller heat transfer as well as a reduction of stress on the heating layer 40c (metallic layer) caused by a thermal expansion of the elastomer rubber.

The heating layer 40c is a thin metallic layer of, for example, 30 micro-meters (hereinafter, “μm”) to 100 μm thickness, made from a metal such as nickel, iron, stainless steel, and the like that has a high thermal conductivity ratio. The elastic layer 40d is formed from a heat-resistant elastomer rubber; for example, a silicon rubber, a fluorocarbon rubber, and the like with a thickness of about 0.8 millimeter. The elastic layer 40d provides elasticity to follow the irregular surfaces of the recordable media P and the toner image T. Since the elastic layer 40d is positioned outside the heating layer 40c, a material that has a high thermal conductivity ratio is preferable. The exfoliating layer 40e ensures exfoliation without a necessity to coat the surface of the heating roller 40 with oil. The exfoliating layer 40e is made from a fluorocarbon resin, such as PFA, PTFE, and the like, or from a silicon resin, or rubber; and has a thickness of 10 μm to 80 μm. The use of a fluorocarbon resin such as PFA, PTFE, or the like, which is more resistant to abrasion and scratches than a silicon rubber, can increase the durability of the heating roller 40.

The pressurizing roller 41 has a metallic tube 41a at the center. The metallic tube 41a is made of a material with high thermal conductivity, such as iron, copper, aluminum, or the like. An insulating layer 41b, an elastic layer 41c, an exfoliating layer 41d that are all made of materials similar those of the abovementioned heating roller 40 are provided in order around the metallic tube 41a. A biasing unit (not shown) maintains a nip section between the pressurizing roller 41 and the heating roller 40. A driving unit (not shown) drives the heating roller 40 which, in turn, drives the pressurizing roller 41.

A revolution detecting plate 42 is attached to a casing 36a of the image fixing apparatus 36. The revolution detecting plate 42 includes a gear-like member 42a that has many blades. The revolution detecting plate 42 continuously revolves as the pressurizing roller 41 grasps and releases the blades of the gear-like member 42a. A photosensor 45 detects the revolutions of the pressurizing roller 41 as the blades of the gear-like member 42a block light to the photosensor 45.

A separating plate 46 exfoliates the recordable media P from the heating roller 40.

An induction-heating unit 50 is arranged in a casing 61 which, in turn, is attached to a main body of the image forming apparatus 60. The induction-heating unit 50 heats the heating roller 40 by means of electromagnetic induction. The induction-heating unit 50 can be configured, for example, from a magnetic field generating unit such as an excitation coil 51, and a strongly magnetic material, such as ferrite, wrapped around an excitation coil core 52. It is also possible to employ a unit or an apparatus that has another configuration that is appropriate for inductive heating.

A thermistor 43 is positioned inside the casing 61 in the vicinity of the heating roller 40 to act as a temperature detecting element. A thermostat 44 is also positioned inside the casing 61 in the vicinity of the heating roller 40 to act as an overheating-prevention element. It is acceptable to install the thermistor 43 and the thermostat 44 at the positions most conducive to their optimal performance, so the installation positions are not limited to those shown in FIGS. 2A and 2B.

The photosensor 45 is attached to the casing 61 which, in turn, is attached to the main body of the image forming apparatus 60. The photosensor 45 is equipped with light-emitting elements and light-receiving elements between which the blades of the gear-like member 42a of the revolution detecting plate 42 pass. The passage of the blades of the gear-like member 42a obstructs the reception of light by the light-receiving element, and this obstruction of light is used to measure the revolutions of the heating roller 40 and the pressurizing roller 41. It is also acceptable to use any other configuration to detect the revolutions of the heating roller 40 and the pressurizing roller 41.

Thus, in the image fixing apparatus 36, the non-electrical components such as the heating roller 40, the pressurizing roller 41, and the like are assembled into one unit; and the induction-heating unit 50 and other electrical components are mounted onto the main body of the image forming apparatus 60. As a result, all of the electrical components, including the induction-heating unit 50, the thermistor 43, the thermostat 44, the photosensor 45, and the harnesses and connectors used by these components, can all remain as-is in the main body of the image forming apparatus 60 when a non-electrical component is replaced. A result is a reduction of costs when a faulty non-electrical component is replaced.

Moreover, since the configuration of the unitized image fixing apparatus is greatly simplified, it is superior from the viewpoint of resource conservation because assembly time is shortened, and time and cost are not wasted for an unnecessary replacement of still-usable electrical components.

It is preferable to decide how to install a replacement non-electrical component without disruption to the positional relationships between the replacement component and the other components that remain inside the image forming apparatus 60. For this reason, a section of each component inside the main body of the image forming apparatus 60 has a position-indicating member (omitted from FIGS. 2A or 2B, but any applicable disclosed method is acceptable) to decide the predetermined positional relationships of the components by a physical contact of the position-indicating member to the heating roller 40. It is preferable to provide members that are configured to revolve at the places of physical contact so abrasion is not generated.

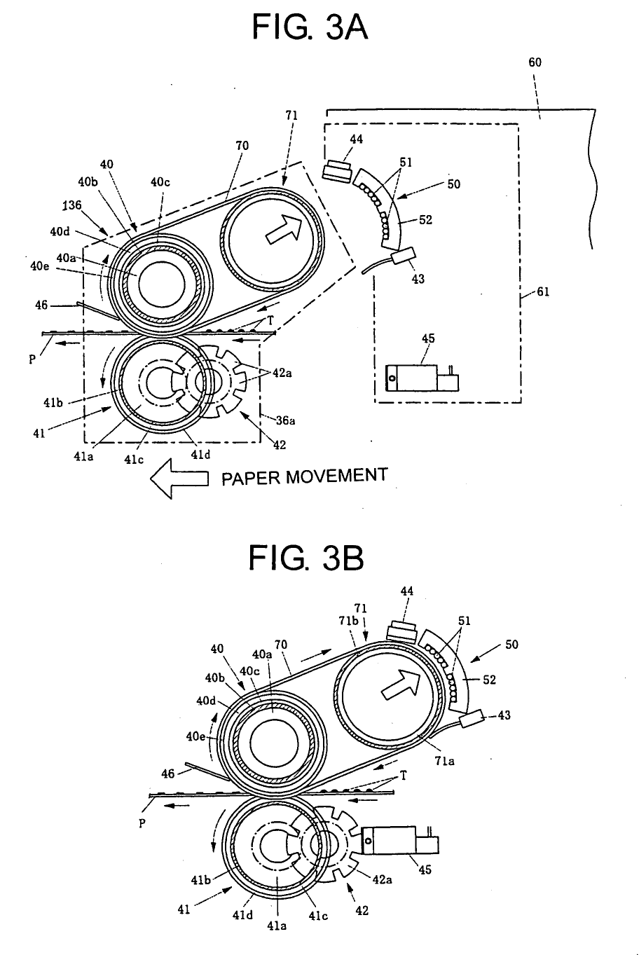

FIGS. 3A and 3B are schematic side-views of a heating apparatus and an image fixing apparatus 136 according to a second embodiment of the present invention. Specifically, FIG. 3A is a schematic side-view of the heating apparatus detached from the image fixing apparatus 136. FIG. 3B is a schematic side-view of the heating apparatus attached to the image fixing apparatus 136. The image fixing apparatus 136 is basically similar to the image fixing apparatus 36 of the first embodiment, except that the image fixing apparatus 136 further includes a tension roller 71 and a heating belt 70. The tension roller 71 revolves the heating belt 70, and is positioned on a longitudinal axis with the heating roller 40. Another point of difference is that the heating belt 70 is heated by the electromagnetic induction generated by the induction-heating unit 50.

The heating belt 70 is made from a base material (metallic heating layer) that is a magnetized metal such as iron, cobalt, nickel, and the like, or some alloy. The heating belt 70 can be a composite belt that has a surface exfoliating layer made of an elastic material such as a silicon rubber or a fluorocarbon rubber; or a nickel-electrotyped base material upon which an elastic layer and an exfoliating layer, such as Teflon (registered trademark) is applied; or a polyimide layer upon which metallic heating layers, elastic layers, and exfoliating layers are applied. There are a variety of composite belt materials that can be used. The heating belt 70 receives electromagnetic induction from an opposing induction-heating unit 50, generates heat, and warms up. These details of the heating belt 70 are omitted from FIGS. 3A and 3B.

Thus, the non-electrical components of the image fixing apparatus 136, such as the heating roller 40, the pressurizing roller 41, the heating belt 70, the tension roller 71, and the like, are assembled to form one unit. Moreover, almost all the electrical components, such as the induction-heating unit 50 and other electrical elements, are placed outside the assembly of the non-electrical components and mounted on the main body of the image forming apparatus 60. When the non-electrical components unit is replaced, all of the electrical components, including the induction-heating unit 50, the thermistor 43, the thermostat 44, the photosensor 45, and the harnesses and connectors used by these components, can all remain as-is in the main body of the image forming apparatus 60. As a result, it is possible to. reduce replacement costs when the non-electrical components unit of the image fixing apparatus 136 is replaced.

Since the configurations of the electrical component unit and the non-electrical component unit are simple, it is superior from the viewpoint of resource conservation because assembly time is shortened and a replacement of still-usable components is avoided.

In this second embodiment, when a new image fixing unit is installed, a position-determining member (not shown) is used to decide the positions of the heating belt 70 and the tension member 71 in relation to the other components. Other than this difference, it is acceptable to employ a configuration similar to that of the first embodiment.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A heating apparatus comprising:
a mechanical assembly that is detachably attached to a host apparatus, and includes a revolving body that generates heat due to electromagnetic induction; and
an electrical assembly that is fixed to the host apparatus, and generates a magnetic field for the electromagnetic induction.

2. The heating apparatus according to claim 1, wherein the revolving body is a roller that is made of a material that generates heat due to the electromagnetic induction.

3. The heating apparatus according to claim 1, wherein the revolving body is a belt that is made of a material that generates heat due to the electromagnetic induction.

4. The heating apparatus according to claim 1, wherein the electrical assembly includes an induction coil that generates a magnetic field for the electromagnetic induction.

5. The heating apparatus according to claim 1, wherein the electrical assembly includes a temperature detecting element that detects a temperature of the revolving body and a temperature controlling element that based on the temperature detected by the temperature detecting element controls generation of the magnetic field so that the revolving body is heated to a predetermined temperature.

6. The heating apparatus according to claim 1, wherein the electrical assembly includes a revolution detecting element that detects revolution of the revolving body.

7. An image fixing apparatus that fixes an image on a recording medium by applying pressure and heat, comprising:
a mechanical assembly that is detachably attached to an image forming apparatus, and includes a revolving body that generates the pressure and generates the heat due to electromagnetic induction; and
an electrical assembly that is fixed to the image forming apparatus, and generates a magnetic field for the electromagnetic induction.

8. The image fixing apparatus according to claim 7, wherein the revolving body is a roller that is made of a material that generates heat due to the electromagnetic induction.

9. The image fixing apparatus according to claim 7, wherein the revolving body is a belt that is made of a material that generates heat due to the electromagnetic induction.

10. The image fixing apparatus according to claim 7, wherein the electrical assembly includes an induction coil that generates a magnetic field for the electromagnetic induction.

11. The image fixing apparatus according to claim 7, wherein the electrical assembly includes a temperature detecting element that detects a temperature of the revolving body and a temperature controlling element that based on the temperature detected by the temperature detecting element controls generation of the magnetic field so that the revolving body is heated to a predetermined temperature.

12. The image fixing apparatus according to claim 7, wherein the electrical assembly includes a revolution detecting element that detects revolution of the revolving body.

13. An image forming apparatus comprising:
an image developing apparatus that forms a toner image on an image holding body;
an image transferring apparatus that transfers the toner image to a recording medium; and
an image fixing apparatus that fixes the toner image to the recording medium by applying pressure and heat, the image fixing apparatus including
a mechanical assembly that is detachably attached to the image forming apparatus, and includes a revolving body that generates the pressure and generates the heat due to electromagnetic induction; and
an electrical assembly that is fixed to the image forming apparatus, and generates a magnetic field for the electromagnetic induction.

14. The image forming apparatus according to claim 13, wherein the revolving body is a roller that is made of a material that generates heat due to the electromagnetic induction.

15. The image forming apparatus according to claim 13, wherein the revolving body is a belt that is made of a material that generates heat due to the electromagnetic induction.

16. The image forming apparatus according to claim 13, wherein the electrical assembly includes an induction coil that generates a magnetic field for the electromagnetic induction.

17. The image forming apparatus according to claim 13, wherein the electrical assembly includes a temperature detecting element that detects a temperature of the revolving body and a temperature controlling element that based on the temperature detected by the temperature detecting element controls generation of the magnetic field so that the revolving body is heated to a predetermined temperature.

18. The image forming apparatus according to claim 13, wherein the electrical assembly includes a revolution detecting element that detect revolution of the revolving body.
